(19) United States
(12) Patent Application Publication
(10) Pub. No.: US 2017/0300671 A1
(43) Pub. Date: Oct. 19, 2017

(54) AUTOMATICALLY MANAGING OPERATION ACROSS MULTIPLE PERSONAS IN ELECTRONIC DEVICE

(71) Applicant: AgreeYa Mobility Inc., Mountain View, CA (US)

(72) Inventor: Raghu Sesha Iyengar, Bangalore (IN)

(21) Appl. No.: 15/486,863

(22) Filed: Apr. 13, 2017

(30) Foreign Application Priority Data
Apr. 14, 2016 (IN) 201641013162

(51) Int. Cl. G06F 21/30

(52) U.S. Cl. CPC G06F 21/30; G06F 2221/2141

(57) ABSTRACT

Embodiments herein achieve a method for managing at least one operation in an electronic device. The method includes detecting, by a persona manager, at least one user-defined persona including a set of access permissions in the electronic device. Further, the method includes automatically creating, by the persona manager, one or more system-defined persona(s) including access permission to perform the at least one operation in the electronic device. The access permission associated with one or more system-defined persona(s) is dynamically defined based on the access permissions associated with the user-defined persona. Further, the method includes detecting, by the persona manager, an event in the user-defined persona based on the access permission of the user-defined persona. Furthermore, the method includes dynamically switching, by the persona manager, from the user-defined persona to the at least one system-defined persona.

### TECHNICAL FIELD

The present disclosure relates to a persona management in an electronic device, and more particularly to a method and electronic device for automatically managing an operation across multiple personas. The present application is based on, and claims priority from Indian provisional application No. 201641013162 filed on Apr. 14, 2016 the disclosure of which is hereby incorporated by reference.

### BACKGROUND

An operating system can virtualize a user space which is used to separate multiple personas. One such implementation is Namespaces in a Linux operating system, using which user space containers are created in a vast number of systems. In a multi-container system, typically one container is more restrictive than the others (e.g., work Vs personal). Triggers and techniques to apply such restrictions are defined in some existing methods to perform operation in the multi-container system.

Further, each of the personas may have a unique set of user preferences, which may correspond to a unique execution environment for each persona. It is common to define a role for each persona. In an example, on a mobile platform, one persona may be used for work, while another persona may be used as personal. It becomes essential to restrict or tightly control the permissions of each persona. Certain actions may have to be restricted only in certain persona and not in others. In an example, the actions could be, but not restricted to, access to a specific hardware, transmit a specific message or the like.

The trigger for such restrictions may be, but not restricted to, based on the persona itself, a physical location of an electronic device, particular action performed by the user, specific inputs received on a plurality of sensors present on the electronic device.

The conventional systems on electronic devices for managing plurality of persona have mechanisms to enforce such restrictions and more particularly provide security in terms of operations performed in the personas. Further, there remains is a need to monitor the operations performed inside a container and change permissions for activities that a user can perform based on certain triggers from sensors, timers, position or the like.

### SUMMARY

Embodiments herein disclose a method for managing one or more operations in an electronic device. The method includes detecting, by a persona manager, at least one user-defined persona including a set of access permissions in the electronic device. Further, the method includes automatically creating, by the persona manager, one or more system-defined personas including access permission to perform the at least one operation in the electronic device. The access permission associated with one or more system-defined personas is dynamically defined based on the access permissions associated with the user-defined persona.

In an embodiment, the method includes detecting, by the persona manager, an event in the user-defined persona based on the access permission of the user-defined persona. Further, the method includes dynamically switching, by the persona manager, from the user-defined persona to the at least one system-defined persona.

In an embodiment, the at least one system-defined persona includes access permission different than the access permissions associated with the user-defined personas.

In an embodiment, the access permission associated with the at least one system-defined persona is dynamically defined based on a function of access permissions of at least one persona available in the electronic device.

In an embodiment, the access permission is automatically enabled in the system-defined persona when the event is detected by the persona manager.

In an embodiment, the access permission to perform the operation in the at last one system-defined personas is allowed when one of the access permission is allowed by at least one of the plurality of personas available in the electronic device and the access permission is allowed by each of the plurality of personas available in the electronic device.

In an embodiment, the access permission associated with the at least one system-defined persona is dynamically updated as and when personas created in the electronic device.

Embodiments herein disclose a method for managing at least one of operation in an electronic device comprising a plurality of personas. The method includes detecting, by a persona manager, an event in a user-defined persona based on an access permission of the user-defined persona. Further, the method includes dynamically switching, by the persona manager, from the user-defined persona to at least one system-defined persona. The system-defined persona includes an access permission different than an access permission associated with the user-defined persona to perform the at least one operation in the electronic device.

Embodiments herein disclose an electronic device includes a memory, a processor, and a persona manager. The persona manager is in communication with the memory and the processor. The persona manager is configured to detect at least one user-defined persona including a set of access permissions in the electronic device. The persona manager is configured to automatically create at least one system-defined persona including access permission to perform the operations in the electronic device. The access permission associated with the at least one system-defined persona is dynamically defined based on the access permissions associated with the at least one user-defined persona.

Embodiments herein disclose an electronic device includes a memory, a processor, and a persona manager. The persona manager is in communication with the memory and the processor. The persona manager is configured to detect an event in a user-defined persona based on an access permission of the user-defined persona. Further, the persona manager is configured to dynamically switch from the user-defined persona to at least one system-defined persona. The system-defined persona includes an access permission different than an access permission associated with the user-defined persona to perform the at least one operation in the electronic device.

Accordingly the embodiment herein provides a computer program product including a computer executable program code recorded on a computer readable non-transitory storage medium. The computer executable program code when executed causing the actions including detecting, by a persona manager, at least one user-defined persona including a set of access permissions in an electronic device. The computer executable program code when executed causing the actions including automatically creating, by the persona manager, one or more system-defined persona(s) including access permission to perform the at least one operation in the electronic device. The access permission associated with one or more system-defined persona(s) is dynamically defined based on the access permissions associated with the user-defined persona. Accordingly the embodiment herein provides a computer program product including a computer executable program code recorded on a computer readable non-transitory storage medium. The computer executable program code when executed causing the actions including detecting, by a persona manager, an event in a user-defined persona based on an access permission of the user-defined persona. The computer executable program code when executed causing the actions including switching, by the persona manager, from the user-defined persona to at least one system-defined persona. The system-defined persona includes an access permission different than an access permission associated with the user-defined persona to perform the at least one operation in the electronic device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

This invention is illustrated in the accompanying drawings, throughout which like reference letters indicate corresponding parts in the various figures. The embodiments herein will be better understood from the following description with reference to the drawings, in which:

FIG. 1 illustrates various units of an electronic device for automatically managing an operation across multiple personas, according to embodiments as disclosed herein;

FIG. 2 is a layer level depiction in which operating system running on the electronic device which supports multiple personas, according to embodiments as disclosed herein;

FIG. 3 is a flow chart illustrating various operations performed to automatically create a plurality of system-defined personas to provide access permission to perform one or more operations in the electronic device, according to an embodiment as disclosed herein;

FIG. 4 is a flow chart illustrating various operations performed to dynamically switch from a user-defined persona to the system-defined persona from the plurality of personas based on the access permission of the user-defined personas, according to an embodiment as disclosed herein;

FIG. 5 is a flow chart illustrating detailed operations performed to create the system-defined persona while detecting an event in the electronic device, according to an embodiment as disclosed herein;

FIG. 6 is a flow chart illustrating detailed operations performed to switch one persona to another persona in the electronic device while detecting the event in the electronic device, according to an embodiment as disclosed herein; and

FIG. 7 illustrates a computing environment implementing a method for managing the operation in the electronic device, according to embodiments as disclosed herein.

### DETAILED DESCRIPTION OF EMBODIMENTS

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure Likewise, the blocks of the embodiments may be physically combined into more complex blocks without departing from the scope of the disclosure.

Throughout the description, the terms “system-defined persona” and “special persona” are used interchangeably.

The embodiments herein disclose an electronic device including a persona manager in communication with a memory and a processor. The persona manager is configured to detect at least one user-defined persona including a set of access permissions in the electronic device. The persona manager is further configured to automatically create at least one system-defined persona includes access permission to perform the operations in the electronic device. The access permission associated with the at least one system-defined persona is dynamically defined based on the access permissions associated with the at least one user-defined persona.

Unlike the conventional methods, the proposed method can be used to assist in handling the case of an unauthorized access in a more graceful manner rather than to immediately stop all permissions by brute force. The proposed method can be used to actively monitor the operations performed inside a persona and automatically modify the permissions for the operations in the persona.

Unlike the conventional methods, the proposed method can be used to monitor the operations performed inside the container and change permissions for activities that the user can perform based on certain triggers from sensors, timers, position or the like. Consider an example in which the electronic device includes three personas, where a first persona allows to access a call facility feature and a Wireless Fidelity (Wi-Fi) connection feature. The second persona allows to access the call facility feature, the Wi-Fi connection feature and a Bluetooth connectivity feature. The third persona allows to access the call facility feature, the Bluetooth connectivity feature and a camera function. If the electronic device detects that the user is in a high security place (e.g., army headquarter, atomic research center or the like) then, the proposed method allows the electronic device to automatically create a restricted persona to allow the user to access only the call facility feature. The access permission is provided based on commonly available permissions in all three personas.

Consider another example in which the electronic device includes three personas, where a first persona allows to access the call facility feature and the Wi-Fi connection feature. The second persona allows to access the call facility feature, the Wi-Fi connection feature and the Bluetooth connectivity feature. The third persona allows to access the call facility feature, the Bluetooth connectivity feature and the camera function. If the electronic device detects that the user is in a hill station then, the proposed method allows the electronic device to automatically create a special persona to allow the user to access all features (i.e., call facility feature, Wi-Fi connection feature, Bluetooth feature, and camera function). The access permissions are provided based on any one of the available permission in all three personas.

Consider yet another example in which the electronic device includes two personas (i.e., user-defined persona and root persona). The user-defined persona includes the restrictive permissions and the root persona includes all permissions. Further, the user-defined persona is launched with restrictive permissions for a specific operation (e.g., launching a game application after 9 PM). If the operation is restricted by the user-defined persona, then a root persona is responsible to switch to the user-defined persona on an appropriate trigger. In an example, the trigger could be when the root persona senses that the user-defined persona try to use the game application after 9 PM which it does not have the authorization. The trigger is detected based on the timer.

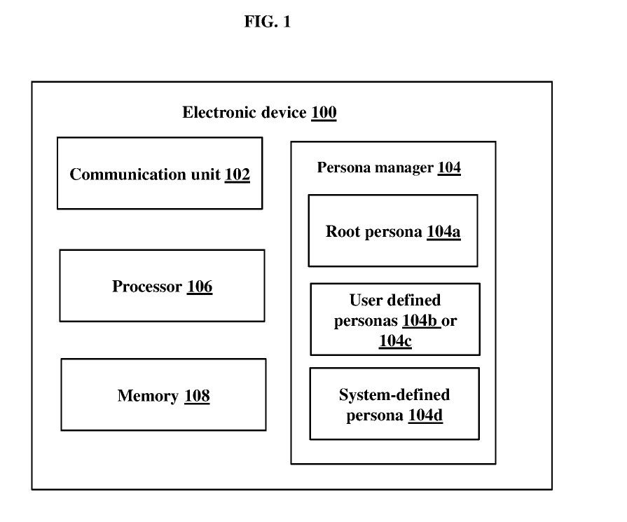

Referring now to the drawings and more particularly to FIGS. 1 through 7, where similar reference characters denote corresponding features consistently throughout the figure, there are shown preferred embodiments.

FIG. 1 illustrates various units of the electronic device 100 for automatically managing an operation across multiple personas, according to embodiments as disclosed herein. The electronic device 100 can be, but is not limited to, a cellular phone, a tablet device, a notebook computer, a smart phone, a laptop, an in-vehicle infotainment system, a wearable computing device, a smart television, or the like. In an embodiment, the electronic device 100 includes a communication unit 102, a persona manager 104, a processor 106 and a memory 108. The persona manager 104 is in communication with the memory 108 and the processor 106. The communication unit 102 is configured for communicating internally between internal units and with external devices via one or more networks. The persona manager 104 monitors the operation in a root persona 104a, user-defined personas 104b and 104c, and a system-defined persona 104d. The persona belonging to the electronic device 100 is called as the root persona 104a. The root persona 104a manages, controls and commands the user-defined personas 104b and 104c in the electronic device 100.

Further, each of the plurality of persona (i.e., root persona 104a, user-defined personas 104b and 104c, and system-defined persona 104d) has unique set of user preferences and permissions which results in a unique execution environment for each persona.

The user-defined personas 104b and 104c typically represent a set of user preferences, permissions resulting in a particular role for the personas. In an example, the persona 104b may be configured to have preferences suitable to use the electronic device 100 in a more restrictive office environment (also typically referred as ‘work’ persona), while persona 104c may be a more casual ‘personal’ persona.

Further, the root persona 104a which is a root container typically has more permission to perform operations compared to the other personas 104b and 104c. The root persona 104a may also monitor the other personas 104b and 104c on a regular basis, which may or may not be configurable, and decide if the other personas 104b and 104c are trying to perform operations which they are not allowed to perform.

Further, the persona manager 104 is configured to detect one or more user-defined persona 104b and 104c including the set of access permissions. After detecting the user-defined personas 104b and 104c including the set of access permissions, the persona manager 104 is configured to automatically create one or more system-defined personas 104d including access permission to perform one or more operation in the electronic device 100. In an embodiment, the system-defined persona 104d can be a special persona. In an embodiment, the system-defined persona 104d can be a restrictive persona. The access permission associated with the system-defined persona 104d is dynamically defined based on the access permissions associated with the user-defined personas 104b and 104c.

In an embodiment, the persona manager 104 is configured to detect an event in the user-defined personas 104b and 104c based on the access permission of the user-defined personas 104b and 104c. In an example, the event could be, but not restricted to, a user action, a pre-configured setup during boot of the electronic device 100. In an embodiment, the event for the permission may be, but not restricted to, based on the persona itself, a physical location of the electronic device 100, particular action performed by the user, specific inputs received on a plurality of sensors present on the electronic device 100. After detecting the event in the user-defined personas 104b and 104c, the electronic device 100 is configured to dynamically switch from the user-defined personas 104b and 104c to the system-defined persona 104d.

After detecting the event in the user-defined personas 104b and 104c, the persona manager 104 is configured to dynamically switch from the user-defined personas 104b and 104c to the system-defined persona 104d.

In an embodiment, the system-defined persona 104d includes the access permission different than the access permissions associated with the user-defined personas 104b and 104c.

In an embodiment, the access permission associated with the system-defined persona 104d is dynamically defined based on a function of access permissions of the personas 104a-104c available in the electronic device 100.

In an embodiment, the access permission is automatically enabled in the system-defined persona 104d when the event is detected by the persona manager 104.

In an embodiment, the access permission to perform the operation in the system-defined personas 104d is allowed when one of the access permission is allowed by at least one of the plurality of personas 104a-104d available in the electronic device 100 and the access permission is allowed by each of the plurality of personas 104a-104c available in the electronic device 100.

In an embodiment, the access permission associated with the system-defined persona 104d is dynamically updated as and when personas created in the electronic device 100.

In an embodiment, one of the personas 104b and 104c may include the special persona. Further, the special persona can be designated as an active persona. In one embodiment, the active persona may interface to all the users using the electronic device 100 while the other personas may run in a background.

The preferences and permissions of the special persona depend on the other personas 104b and 104c that are present in the electronic device 100 at a given time. Further, the preferences and permissions of the special persona may or may not change when one or more of the personas 104b and 104c are created, destroyed or modified.

The root persona 104a may set one of the other personas 104b and 104c as the active persona which may be in reaction to the trigger.

In an embodiment, the preferences and permissions of the special persona may be derived from the preferences and permissions of the other personas 104b and 104c as union operations.

In an embodiment, the preferences and permissions of the special persona may be derived from the preferences and permissions of the other personas 104b and 104c as intersection operations.

In an embodiment, the preferences and permissions of the special persona may be derived from the preferences and permissions of the other personas 104b and 104c as logical operations.

In an embodiment, the preferences and permissions of the special persona may be derived from the preferences and permissions of the other personas 104b and 104c as arithmetic operations.

In an embodiment, the persona 104b and 104c may have completely different permissions to perform particular operation, which may include, but not restricted to, access to hardware, transmit specific message, change hardware configuration or the like. For one particular operation, the persona 104b may have the permissions while the other persona 104c may not have the permissions. For another operation, the persona 104b may have the permissions while the persona 104c may not.

Further, the special persona is configured to be a default target persona when the persona switching happens under specific conditions. In an embodiment, the special persona may have the permissions set to the intersection of permissions of the personas 104b and 104c in the electronic device 100, such that the special persona has the least permissions of the personas 104b and 104c. When the root persona 104a decides to switch to most restrictive persona due to any of the trigger, the special persona may be the default target.

In an embodiment, the special persona may have the permissions set to the union of the permissions of the persona 104b and 104c. Further, the special persona becomes the default target for the persona switch, when the root persona 104a decides to switch to the least restrictive persona due to any of the event.

In an example, the special persona is created while booting by an operating system. The personas 104b and 104c are created on request from the user of the electronic device 100 and have the permissions based on the nature of request. The special persona is created by the personas 104b and 104c, and the root persona 104a. The permissions of the system defined persona 104d are an intersection of the permissions of all the user containers (i.e., personas 104b and 104c, and root persona 104a). The table 1 summarizing the relation between the permissions of the special persona and the permissions of other user personas 104a-104c are shown as below:

TABLE 1

| | Root persona | Persona | Persona | system defined |
|---|---|---|---|---|
| Feature | 104a | 104b | 104c | persona 104d |
| A | Y | Y | Y | Y |
| B | Y | Y | N | N |
| C | Y | N | Y | N |
| D | Y | N | N | N |

The system defined persona 104d is created by the personas 104b and 104c, and the root persona 104a. The permissions of the system defined persona 104d are logical OR function of the permissions of all the user containers (i.e., personas 104b and 104c, and root persona 104a). The table 2 summarizing the relation between the permissions of the system defined persona 104d and the permissions of other user personas 104a-104c are shown as below:

TABLE 2

| | Root persona | Persona | Persona | System defined |
|---|---|---|---|---|
| Feature | 104a | 104b | 104c | persona 104d |
| A | Y | Y | Y | Y |
| B | Y | Y | N | Y |
| C | Y | N | Y | Y |
| D | Y | N | N | N |

In an embodiment, the system defined persona 104d is created by the root persona 104a when one of the other personas 104b and 104c are created. The personas 104b and 104c may be created by the trigger from a user or a pre-configured trigger during or after the electronic device 100a boots up.

In an example, the first user-defined persona 104b is launched with more restrictive permissions for the specific operation (e.g., launching a Wi-Fi application) in a specific region (i.e., restricted place in a military field). If the operation is restricted by at least one user-defined persona 104b or 104c, then the root persona 104a is responsible to switch to the user-defined persona 104b on an appropriate trigger. In an example, the trigger could be when the root persona 104a senses that one of the user-defined persona 104b or 104c s trying to activate Wi-Fi application in the restricted region which it does not have the authorization.

In an example, the first user-defined persona 104b is launched with more restrictive permissions for the specific operation (e.g., taking a selfie) in an edge of a roof terrace of a tall building. If the operation is restricted by at least one user-defined persona 104b or 104c, then the root persona 104a is responsible to switch to the user user-defined persona 104b on the appropriate trigger. In an example, the trigger could be when the root persona 104a senses that one of the user-defined persona 104b or 104c is trying to capture selfie in the edge of the roof terrace of the tall building. The edge of the roof terrace of the tall building is detected by at least one location sensor, a GPS or the like.

In another example, the first user-defined persona 104b is launched with more restrictive permissions for the specific operation (e.g., accessing a sensitive application in a regulated domain). The regulated domain correspondents to a financial domain and a healthcare domain. If the operation is restricted by at least one user-defined persona 104b or 104c, then the root persona 104a is responsible to switch to the user user-defined persona 104b on the appropriate trigger. In an example, the trigger could be when the root persona 104a senses that one of the user-defined persona 104b or 104c is trying to access the sensitive application in the regulated domain.

Further, the memory 108 stores the policies and permission information associated with the plurality of personas 104a-104c. Further, the memory 108 stores logs of all the operations into a logging system (not shown), which may be a file on a hard disk (not shown). This information may be used on a regular basis to decide if any of the persona 104b and 104c can cause a potential security threat to the electronic device 100. Further, the memory 108 may include one or more computer-readable storage media. The memory 108 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the memory 108 may, in some examples, be considered a non-transitory storage medium. The term “non-transitory” may indicate that the storage medium is not embodied in a carrier wave or a propagated signal.

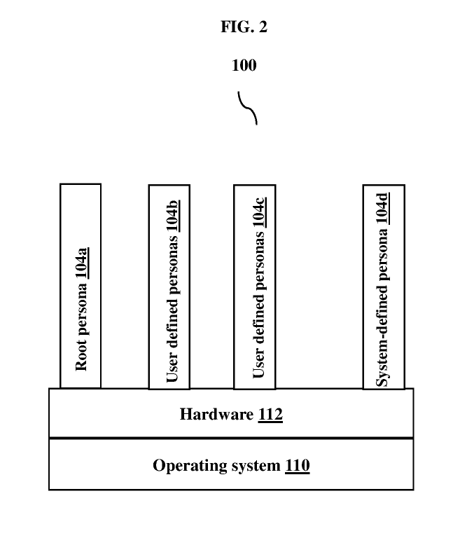

Referring to details of the FIG. 2, the operations and functionalities of the personas 104a-104d are explained in conjunction with the FIG. 1. Further, the electronic device 100 includes an operating system 110 and a hardware 112. The hardware 112 includes a printed circuit board with integrated chips, casing, cables and related items.

The hardware 112 is capable of running software, generally referred to as operating system 110 which allows the users to access configure and communicate with the hardware 112. The operating system 110 is capable of supporting multiple personas 104a-104d at same time. The root persona 104a or the operating system 110 monitors the operations of the entire personas 104b and 104c.

In any of the electronic device 100 that uses multiple personas (e.g., one for work and one for personal), there is always a need to identify and restrict any attempt by the personas 104b and 104c when personas 104b and 104c tries to perform the operation which it is not supposed to. In conventional methods, there are many methods are available. However, none of the methods perform this kind of restriction by switching back to a pre-defined, minimalistic container. Unlike the conventional methods, the obvious benefit of the proposed method is that it helps in handling the case of an unauthorized access in a more graceful manner (rather than to immediately stop all permissions in brute force). Further, the proposed method can be used to dynamically decide the permissions level of the personas 104a-104d.

Some of the conventional methods trigger the switch in the personas 104b and 104c when the specific action is detected and also define the kinds of triggers that could cause such kind of switch. However, unlike the proposed method they do not discuss about the ‘restrictive’ container that has the permissions that form the intersection of the permissions of all the available containers.

The FIG. 1 and the FIG. 2 show the limited overview of the electronic device 100 but, it is to be understood that other embodiments are not limited thereto. Further, the electronic device 100 can include any number any number of hardware and software components communicating with each other. In other embodiments, the electronic device 100 may include less or more number of units. Further, the labels or names of the units are used only for illustrative purpose and does not limit the scope of the invention. One or more units can be combined together to perform same or substantially similar function in electronic device 100. The FIG. 1 and the FIG. 2 are only for depiction and a lot of flexibility may be added to the electronic device 100 without affecting the proposed method. In an example, the number of such personas such as 104b and 104c may not be restricted to only two as shown in the FIG. 1.

FIG. 3 is a flow chart 300 illustrating various operations performed to automatically create the plurality of system-defined persona 104d to provide access permission to perform one more operation(s) in the electronic device 100, according to an embodiment as disclosed herein. At step 302, the method includes detecting one or more user-defined personas 104b and 104c including the set of access permissions in the electronic device 100. In an embodiment, the method allows the persona manager 104 to detect one or more user-defined personas 104b and 104c including the set of access permissions in the electronic device 100. At step 304, the method includes automatically creating the system-defined persona 104d including access permission to perform the operations in the electronic device 100. In an embodiment, the method allows the persona manager 104 to automatically create the system-defined persona 104d including the access permission to perform the operations in the electronic device 100.

The various actions, acts, blocks, steps, or the like in the flow chart 300 may be performed in the order presented, in a different order or simultaneously. Further, in some embodiments, some of the actions, acts, blocks, steps, or the like may be omitted, added, modified, skipped, or the like without departing from the scope of the invention.

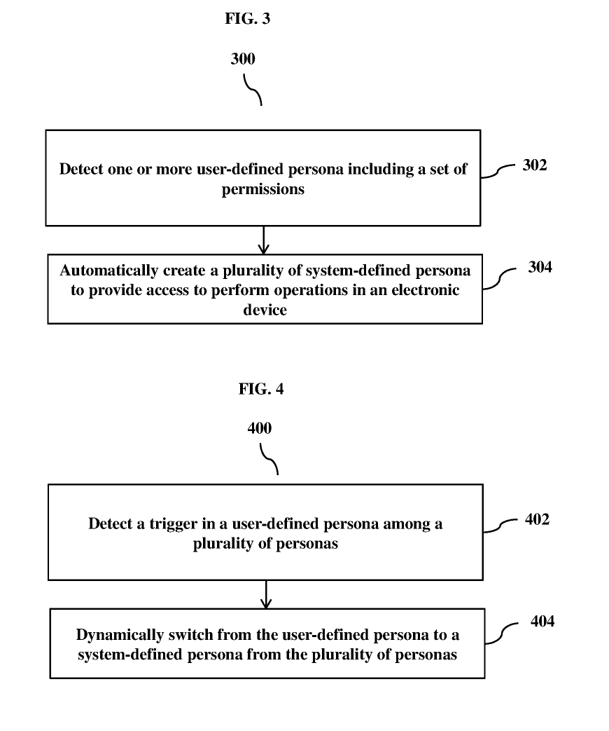

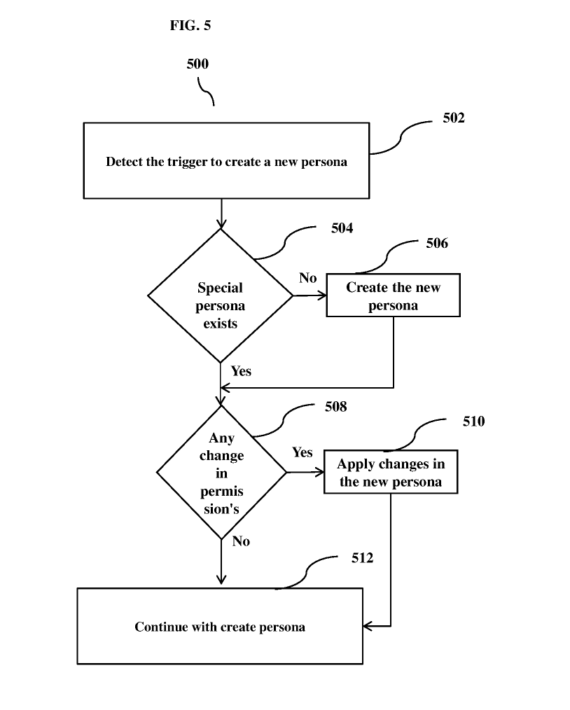

FIG. 4 is a flow chart 400 illustrating various operations performed to dynamically switch from the user-defined persona 104b or 104c to the system-defined persona 104d from the plurality of personas 104a-104c based on the access permission of the user-defined personas 104b and 104c, according to an embodiment as disclosed herein. At step 402, the method includes detecting the event in the user-defined personas 104b and 104c based on the access permission of the user-defined personas 104b and 104c. In an embodiment, the method allows the persona manager 104 to detect the event in the user-defined personas 104b and 104c based on the access permission of the user-defined persona 104b and 104c. At step 404, the method includes dynamically switching from the user-defined personas 104b and 104c to the system-defined persona 104d. In an embodiment, the method allows the persona manager 104 to dynamically switch from the user-defined personas 104b and 104c to the system-defined persona 104d.

In an example, the first user-defined persona 104b is launched with more restrictive permissions for the specific operation (e.g., launching a camera application). If the operation is restricted by at least one user-defined persona 104b or 104c, then the root persona 104a is responsible to switch to the user user-defined persona 104b on the appropriate trigger. In an example, the trigger could be when the root persona 104a senses that one of the user-defined persona 104b and 104c is trying to perform the operation for which it does not have the authorization.

The proposed method can be used to monitor, control and apply permission restrictions on the persona in an effective manner.

The various actions, acts, blocks, steps, or the like in the flow chart 400 may be performed in the order presented, in a different order or simultaneously. Further, in some embodiments, some of the actions, acts, blocks, steps, or the like may be omitted, added, modified, skipped, or the like without departing from the scope of the invention.

FIG. 5 is a flow chart 500 illustrating detailed operations performed to create and modify the system-defined persona 104d while detecting the event in the electronic device 100, according to an embodiment as disclosed herein. At step 502, the method includes detecting the trigger to create a new persona (i.e., system-defined persona 104d). In an embodiment, the method allows the persona manager 104 to detect the trigger to create the new persona. Based on trigger, the root persona 104a starts the process of creating the new persona. In an example, the trigger could be, but not restricted to, the user action, the pre-configured setup during boot of the electronic device 100, or the like. Further, a decision by the root persona 104a based on other inputs the root persona 104a receives, which may come as a result of monitoring the activities of other personas 104b and 104c. The root persona 104a is responsible to create and /or activate the personas 104b and 104c based on polices and permission. Based on polices and permission of the personas 104a-104c, the persona manager 104 creates the personas 104b and 104c.

At step 504, the method includes determining whether the special person 104d exists. In an embodiment, the method allows the persona manager 104 to determine whether the special person 104d exists. If the special person 104d does not exist, at step 506, the method includes creating another persona (i.e., special persona 104d). In an embodiment, the method allows the persona manager 104 to create another persona.

If the special person 104d exists, at step 508, the method including determining whether any change in permissions of the special persona 104d. In an embodiment, the method allows the persona manager 104 to determine whether any change in the permissions of the special persona 104d. If any change in permissions of the special persona 104d then, at step 510, the method includes applying changes in the special persona 104d. In an embodiment, the method allows the persona manager 104 to apply changes in the special persona 104d. In an embodiment, the root persona 104a may further decide if the permissions of the special persona 104d need to be changed. The persona manager 104 applies for the required changes.

If any change in permission does not require in the special persona 104d, then, at step 512, the method includes continue with creating the new persona. In an embodiment, the method allows the persona manager 104 to continue with create the new persona (i.e., special persona 104d).

In an embodiment, the permissions of the special persona 104d could be an intersection of the permissions of all other personas 104b and 104c in the electronic device 100. Hence, the permissions of the special persona 104d may need to be re-evaluated based on the permissions of the newly created personas 104b and 104c.

In another embodiment, the root persona 104a proceeds with creating the personas 104b and 104c as requested by the trigger at step 502. The special persona 104d may also be created after the personas 104b and 104c are created at step 502.

The various actions, acts, blocks, steps, or the like in the flow chart 500 may be performed in the order presented, in a different order or simultaneously. Further, in some embodiments, some of the actions, acts, blocks, steps, or the like may be omitted, added, modified, skipped, or the like without departing from the scope of the invention.

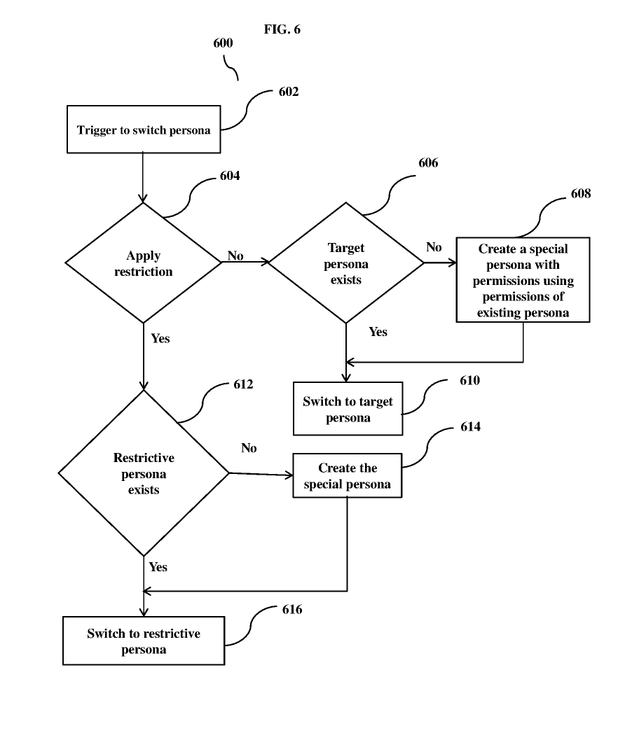

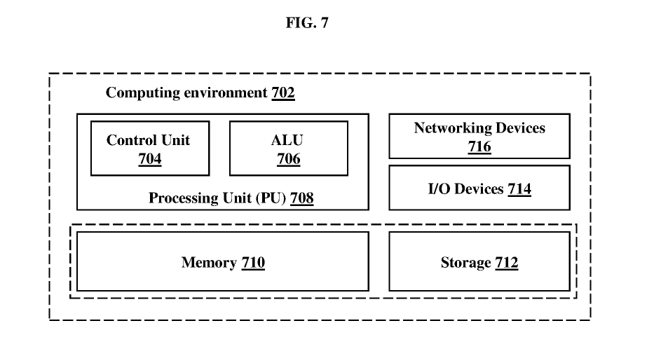

FIG. 6 is a flow chart 600 illustrating detailed operations performed to switch one persona to another persona in the electronic device in the electronic device 100 while detecting the event in the electronic device 100, according to an embodiment as disclosed herein. At step 602, the method includes triggering to switch the persona (i.e., switch from the user-defined personas 104b and 104c to the restrictive persona. In an embodiment, the root persona 104a receives a trigger to switch the active persona in the electronic device 100.

In an embodiment, the trigger received at step 602 may result in a decision at step 604 to switch to the restrictive persona. In this embodiment, the restrictive persona may have permissions that are the intersection of permissions of the personas 104b and 104c.

In another embodiment, if the decision applied at step 604 does not result in any of the restrictive persona. Further, it may result in some other decision at step 606. At step 606, the root persona 104a checks for target persons, if the target persona exists, at step 610 the electronic device 100 switches to the target persona, else at step 608, the electronic device 100 creates the new restrictive persona with permissions formed using set, logical or arithmetic combinations of permissions of the existing persona 104a-104c, where the permissions of the resulting persona may be some other set, logical or arithmetic combination of the permissions of the existing persona 104a-104c.

At step 612, the electronic device 100 checks for any of the restrictive persona as a result of the decision from step 604. If the restrictive persona exists, then the root persona 104a makes the restrictive persona as active at step 616 else the electronic device 100 creates a new persona at 614.

The various actions, acts, blocks, steps, or the like in the flow chart 600 may be performed in the order presented, in a different order or simultaneously. Further, in some embodiments, some of the actions, acts, blocks, steps, or the like may be omitted, added, modified, skipped, or the like without departing from the scope of the invention.

FIG. 7 illustrates a computing environment 702 implementing a method for managing the operations in the electronic device 100, according to an embodiment as disclosed herein. As depicted in the figure, the computing environment 702 comprises at least one processing unit 708 that is equipped with a control unit 704, an Arithmetic Logic Unit (ALU) 706, a memory 710, a storage unit 712, a plurality of networking devices 716 and a plurality Input output (I/O) devices 714. The processing unit 708 is responsible for processing the instructions of the technique. The processing unit 708 receives commands from the control unit 704 in order to perform its processing. Further, any logical and arithmetic operations involved in the execution of the instructions are computed with the help of the ALU 706.

The overall computing environment 702 can be composed of multiple homogeneous or heterogeneous cores, multiple CPUs of different kinds, special media and other accelerators. The processing unit 708 is responsible for processing the instructions of the technique. Further, the plurality of processing units 704 may be located on a single chip or over multiple chips.

The technique comprising of instructions and codes required for the implementation are stored in either the memory unit 710 or the storage 712 or both. At the time of execution, the instructions may be fetched from the corresponding memory 710 or storage 712, and executed by the processing unit 708.

In case of any hardware implementations various networking devices 716 or external I/O devices 714 may be connected to the computing environment 702 to support the implementation through the networking unit and the I/O device unit.

The embodiments disclosed herein can be implemented through at least one software program running on at least one hardware device and performing network management functions to control the elements. The elements shown in the FIGS. 1 to 7 include blocks which can be at least one of a hardware device, or a combination of hardware device and software module.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. An electronic device comprising:
a memory;
a processor; and
a persona manager, in communication with the memory and the processor, configured to:
detect at least one user-defined persona comprising a set of access permissions in the electronic device; and
automatically create at least one system-defined persona comprising access permission to perform the operations in the electronic device, wherein the access permission associated with the at least one system-defined persona is dynamically defined based on the access permissions associated with the at least one user-defined persona.

2. The electronic device of claim 1, wherein the persona manager is further configured to:
detect an event in the user-defined persona based on the access permission of the user-defined persona; and
dynamically switch from the user-defined persona to the at least one system-defined persona.

3. The electronic device of claim 1, wherein the at least one system-defined persona comprises access permission different than the access permissions associated with the user-defined persona.

4. The electronic device of claim 3, wherein the access permission associated with the at least one system-defined persona is dynamically defined based on a function of access permissions of at least one persona available in the electronic device, wherein the access permission is automatically enabled in the system-defined persona when the event is detected by the persona manager.

5. The electronic device of claim 4, wherein the access permission to perform the operation in the at last one system-defined personas is allowed when one of the access permission is allowed by at least one of the plurality of personas available in the electronic device and the access permission is allowed by each of the plurality of personas available in the electronic device.

6. The electronic device of claim 1, wherein the access permission associated with the at least one system-defined persona is dynamically updated as and when personas created in the electronic device.

7. An electronic device comprising:
a memory;
a processor; and
a persona manager, in communication with the memory and the processor, configured to:
detect an event in an user-defined persona based on an access permission of the user-defined persona; and
dynamically switch from the user-defined persona to at least one system-defined persona, wherein the system-defined persona comprises an access permission different than an access permission associated with the user-defined persona to perform the at least one operation in the electronic device.

8. The electronic device of claim 7, wherein the access permission associated with the at least one system-defined persona is dynamically defined based on a function of the access permission of at least one persona available in the electronic device, wherein the access permission is automatically enabled in the system-defined persona when the event is detected by the persona manager.

9. The electronic device of claim 8, wherein the access permission to perform the at least one operation in the at last one system-defined personas is allowed when one of the access permission is allowed by at least one of the plurality of personas available in the electronic device and the access permission is allowed by each of the plurality of personas available in the electronic device.

10. The electronic device of claim 7, wherein the access permission associated with the at least one system-defined persona is dynamically updated as and when personas created in the electronic device.

11. A method for managing operations in an electronic device, the method comprising:
detecting, by a persona manager, at least one user-defined persona comprising a set of access permissions in the electronic device; and
automatically creating, by the persona manager, at least one system-defined persona comprising access permission to perform the operations in the electronic device, wherein the access permission associated with the at least one system-defined persona is dynamically defined based on the access permissions associated with the at least one user-defined persona.

12. The method of claim 11, wherein the method further comprises:
detecting, by the persona manager, an event in the user-defined persona based on the access permission of the user-defined persona; and
dynamically switching, by the persona manager, from the user-defined persona to the at least one system-defined persona.

13. The method of claim 11, wherein the at least one system-defined persona comprises access permission different than the access permissions associated with the user-defined persona.

14. The method of claim 13, wherein the access permission associated with the at least one system-defined persona is dynamically defined based on a function of access permissions of at least one persona available in the electronic device, wherein the access permission is automatically enabled in the system-defined persona when the event is detected by the persona manager.

15. The method of claim 14, wherein the access permission to perform the operation in the at last one system-defined personas is allowed when one of the access permission is allowed by at least one of the plurality of personas available in the electronic device and the access permission is allowed by each of the plurality of personas available in the electronic device.

16. The method of claim 11, wherein the access permission associated with the at least one system-defined persona is dynamically updated as and when personas created in the electronic device.

17. A method for managing operations in an electronic device comprising a plurality of personas, the method comprising:
detecting, by a persona manager, an event in an user-defined persona based on an access permission of the user-defined persona; and
dynamically switching, by the persona manager, from the user-defined persona to at least one system-defined persona, wherein the system-defined persona comprises an access permission different than an access permission associated with the user-defined persona to perform the at least one operation in the electronic device.

18. The method of claim 17, wherein the access permission associated with the at least one system-defined persona is dynamically defined based on a function of the access permission of at least one persona available in the electronic device, wherein the access permission is automatically enabled in the system-defined persona when the event is detected by the persona manager.

19. The method of claim 18, wherein the access permission to perform the at least one operation in the at last one system-defined personas is allowed when one of the access permission is allowed by at least one of the plurality of personas available in the electronic device and the access permission is allowed by each of the plurality of personas available in the electronic device.

20. The method of claim 17, wherein the access permission associated with the at least one system-defined persona is dynamically updated as and when personas created in the electronic device.
